(19) United States
(12) Patent Application Publication
(10) Pub. No.: US 2022/0213258 A1
(43) Pub. Date: Jul. 7, 2022

(54) THERMOPLASTIC POLYURETHANE FILM AND DENTAL APPLIANCES FORMED THEREFROM

(71) Applicant: 3M INNOVATIVE PROPERTIES COMPANY, St. Paul, MN (US)

(72) Inventors: Ta-Hua Yu, Woodbury, MN (US); Timothy J. Hebrink, Scandia, MN (US); Charlie C. Ho, Woodbury, MN (US); Karl J.L. Geisler, Saint Paul, MN (US); Yongshang Lu, Woodbury, MN (US); Jay M. Jennen, Forest Lake, MN (US); David P. Siglin, St. Paul, MN (US)

(21) Appl. No.: 17/604,800

(22) PCT Filed: Apr. 28, 2020
(86) PCT No.: PCT/IB2020/054004

§ 371 Date: Oct. 19, 2021

Related U.S. Application Data
(60) Provisional application No. 62/843,143, filed on May 3, 2019.

(51) Int. Cl. C08G 18/76; C08G 18/12; C08G 18/32; C08G 18/36; C08J 3/24; C08J 5/18; A61C 7/08; B29C 48/00; B29C 48/08; B29C 48/21; B32B 27/40; B32B 27/36; B32B 27/08

(52) U.S. Cl. CPC C08G 18/7671; B29K 2075/00; C08G 18/3206; C08G 18/36; C08J 3/24; C08J 5/18; A61C 7/08; B29C 48/0017; B29C 48/08; B29C 48/022; B29C 48/21; B32B 27/40; B32B 27/36; B32B 27/365; B32B 27/08; C08J 2375/04; C08G 18/12

(57) ABSTRACT

A method includes reactively extruding a polymeric composition to form a film. The polymeric composition includes a polyisocyanate and at least one dimer fatty diol.

### BACKGROUND

Orthodontic treatments involve repositioning misaligned teeth and improving bite configurations for improved cosmetic appearance and dental function. Repositioning teeth is accomplished by applying controlled forces to the teeth of a patient over an extended treatment time period.

Teeth may be repositioned by placing a dental appliance such as a polymeric incremental position adjustment appliance, generally referred to as an orthodontic aligner or an orthodontic aligner tray, over the teeth of the patient. The orthodontic alignment tray includes a polymeric shell with a plurality of cavities configured for receiving one or more teeth of the patient. The individual cavities in the polymeric shell are shaped to exert force on one or more teeth to resiliently and incrementally reposition selected teeth or groups of teeth in the upper or lower jaw. A series of orthodontic aligner trays are provided for wear by a patient sequentially and alternatingly during each stage of the orthodontic treatment to gradually reposition teeth from misaligned tooth arrangement to a successive more aligned tooth arrangement until a desired tooth alignment condition is ultimately achieved. Once the desired alignment condition is achieved, an aligner tray, or a series of aligner trays, may be used periodically or continuously in the mouth of the patient to maintain tooth alignment. In addition, orthodontic retainer trays may be used for an extended time period to maintain tooth alignment following the initial orthodontic treatment.

A stage of an orthodontic treatment may require that a polymeric orthodontic retainer or aligner tray remain in the mouth of the patient for up to 22 hours a day, over an extended treatment time period of days, weeks or even months.

A polymeric material selected for an orthodontic retainer or aligner tray should satisfy a combination of different performance requirements. The polymeric material should effectively exert a stable and consistent repositioning force against the teeth of a patient (force performance persistence) without being too stiff and causing patient discomfort when the dental appliance repeatedly contacts oral tissues or the tongue of a patient over an extended treatment time. The polymeric material should resist moisture absorption and swelling (moisture resistance) in the warm and moist environment in the mouth, which can compromise the mechanical tooth-repositioning properties of the dental appliance. The polymeric material should have good scratch and abrasion resistance, which can prevent damage to the dental appliance following repeated contact of the exposed surfaces of the dental appliance against the teeth of the patient. The polymeric material should resist localized cracking when the patient repeatedly places the dental appliance over the teeth. The polymeric material should also be relatively transparent or translucent, and have good stain resistance when repeatedly contacted by dental cleaning products or common tooth-staining foods consumed by the patient (for example, coffee, tea and red wine) when the dental appliance is in the mouth. The polymeric material should also be easily fabricated into a dental appliance by common processes such as thermoforming, and should be easily trimmable for final fitting of the dental appliance to the teeth and mouth of the patient.

If the polymeric material has less than desirable performance in any of these areas, compromised mechanical properties can reduce tooth repositioning efficiency and undesirably extend the treatment time required to active a desired tooth alignment condition, and the dental appliance can become discolored or damaged over an extended treatment time.

Thermoplastic polyurethane (TPU) is a unique family of polymeric materials created when a polyaddition reaction occurs between a polyisocyanate and one or more diols, which creates repeating urethane groups. TPUs can include hard and soft microdomains, which are strongly chemically bonded together by the urethane links. By combining hard and soft regions, some TPUs can provide good strength and toughness, while remaining relatively flexible.

In some applications, the strength of the urethane linkage can provide TPUs with advantages over other commonly used resins such as polyethylene (PETG), polypropylene (PP) and copolyester, which in some cases have less desirable combination of toughness, strength, and flexibility. TPUs have been used to make dental appliances such as, for example, orthodontic aligner trays, orthodontic retainer trays, temporary bridges, and surgical splints.

### SUMMARY

An improved TPU is needed that provides a dental appliance with an acceptable combination of force performance persistence, patient comfort, moisture resistance, scratch and abrasion resistance, clarity, and resistance to staining. The components used to form the TPU should be reactable at a relatively low temperature, which can reduce or eliminate the likelihood that residual isocyanate or other low molecular weight species remain in the final polymeric product.

In general, the present disclosure is directed to a film that includes a TPU polymer having monomeric units derived from a polyisocyanate, at least one dimer fatty diol, and an optional hydroxyl-functional chain extender. In some embodiments, the polyisocyanate has high reactivity with the optional chain extender and the dimer fatty diol to form hard and soft domains in the TPU polymer, respectively. In some embodiments, the TPU polymer can be reacted and formed into a film by reactive extrusion of a composition including the polyisocyanate, the at least one dimer fatty diol, and the optional hydroxyl-functional chain extender at a temperature of less than 200° C. in the absence of a catalyst, which can minimize residual isocyanate and reduce the formation of low molecular weight species in the extruded film. The film including the TPU polymer can optionally be further modified with crosslinking agents, or may be post-treated with radiation to enhance selected properties of a dental appliance formed therefrom such as, for example, any or all of force persistence, dimensional stability and toughness.

When the TPU polymer-containing film is thermoformed or injection molded into a dental appliance such as an orthodontic aligner or retainer tray, temporary bridges and surgical splints, the dental appliance provides optimal force performance with patient comfort, and possesses good stain resistance, moisture resistance, and mechanical durability.

In one aspect, the present disclosure is directed to a method including reactively extruding a polymeric composition to form a film, the polymeric composition including a polyisocyanate and at least one dimer fatty diol.

In another aspect, the present disclosure is directed to a method for making a dental appliance. The method includes reactively extruding a polymeric composition to form a film, wherein the polymeric composition includes a polyisocyanate and at least one dimer fatty diol; and thermoforming the film to create therein cavities configured to receive one or more teeth and form the dental appliance.

In another aspect, the present disclosure is directed to a polymeric film construction, which includes a first film layer of a thermoplastic polyurethane including a polyisocyanate and at least one dimer fatty diol; and a second film layer including a polyester, a polycarbonate, and mixtures and combinations thereof.

In another aspect, the present disclosure is directed to a polymeric film construction, which includes a first film layer including a polyester, a polycarbonate, and mixtures and combinations thereof; a second film layer including a polyester, a polycarbonate, and mixtures and combinations thereof; and an intermediate film layer between the first film layer and the second film layer, wherein the intermediate film layer is a thermoplastic polyurethane including a polyisocyanate and at least one dimer fatty diol.

In another aspect, the present disclosure is directed to a polymeric film construction, which includes a first film layer of a thermoplastic polyurethane including a polyisocyanate and at least one dimer fatty diol; a second film layer of a thermoplastic polyurethane including a polyisocyanate and at least one dimer fatty diol; and an intermediate film layer between the first film layer and the second film layer, wherein the intermediate film layer includes a polyester, a polycarbonate, and mixtures and combinations thereof.

In another aspect, the present disclosure is directed to a method of making a dental appliance. The method includes co-extruding a first polymeric film composition including a polyisocyanate and at least one dimer fatty diol; and a second polymeric film composition including at least one polyester, to form a multi-layered film with at least one film layer of the first polymeric film composition and at least one film layer of the second polymeric film composition; and thermoforming the multi-layered film to create therein a plurality of cavities for receiving one or more teeth and make the dental appliance.

In another aspect, the present disclosure is directed to a method of making a dental appliance. The method includes extruding, at a temperature of less than about 200° C. a polymeric film composition including a polyisocyanate, at least one dimer fatty diol, and a hydroxyl-functional chain extender to form a polymeric film; and thermoforming the polymeric film to create therein a plurality of cavities for receiving one or more teeth and make the dental appliance.

In another aspect, the present disclosure includes a method of making a dental appliance. The method includes extruding, at a temperature of less than about 200° C. a polymeric film composition including a polyisocyanate, at least one dimer fatty diol, and a hydroxyl-functional chain extender to form a polymeric film; and thermoforming the polymeric film to create therein a plurality of cavities for receiving one or more teeth and make the dental appliance.

In another aspect, the present disclosure is directed to a film with a thickness of less than 1 mm, wherein the film includes a polymer with a first monomeric unit derived from a polyisocyanate and a second monomeric unit derived from a dimer fatty diol.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a schematic overhead perspective view of an embodiment of a multilayered dental appliance.

FIG. 2 is a schematic, cross-sectional view of an embodiment of a multilayered dental appliance of FIG. 1.

FIG. 3 is a schematic, cross-sectional view of an embodiment of a multilayered dental appliance of FIG. 1.

FIG. 4 is a schematic, cross-sectional view of an embodiment of a multilayered dental appliance of FIG. 1.

FIG. 5 is a schematic overhead perspective view of a method for using a dental alignment tray by placing the dental alignment tray to overlie teeth.

FIG. 6 is a schematic representation of the reactive extrusion components used to form the film in Example 1, and also includes a photograph of a dental appliance made by thermoforming the film.

FIG. 7 is a schematic representation of the reactive extrusion components used to form the film in Example 2, and also includes a photograph of a dental appliance made by thermoforming the film.

Like symbols in the drawings indicate like elements.

### DETAILED DESCRIPTION

In one aspect, the present disclosure is directed a polymeric film with a thickness of less than about 1 mm, or less than about 0.80 mm, or less than about 0.50 mm, wherein the polymeric film includes a thermoplastic polyurethane (TPU) polymer with monomeric units derived from a polyisocyanate, at least one dimer fatty diol, and an optional hydroxyl-functional chain extender. In some embodiments, the TPU polymer includes hard microdomains formed by reaction between the polyisocyanate and the optional chain extender, as well as soft microdomains formed by reactions between the polyisocyanate and the dimer fatty diol.

The dimer fatty diols used in the polymeric film are derived from dimer fatty acids, which are dimerization products of mono or polyunsaturated fatty acids and/or esters thereof. The related term trimer fatty acid similarly refers to trimerization products of mono- or polyunsaturated fatty acids and/or esters thereof.

Dimer fatty acids are described in, for example. T. E Breuer, ‘Dimer Acids,’ in J. I. Kroschwitz (ed.). Kirk-Othmer Encyclopedia of Chemical Technology, 4th Ed, Wily, N.Y., 1993, Vol. 8. pp. 223-237. The dimer fatty acids are prepared by polymerizing fatty acids under pressure, and then removing most of the unreacted fatty acid starting materials by distillation. The final product usually contains some small amounts of mono fatty acid and timer fatty acids, but is mostly made up of dimer fatty acids. The resultant product can be prepared with various proportions of the different fatty acids as desired.

The dimer fatty acids used to form the dimer fatty diols are derived from the dimerization products of C10 to C30 fatty acids, C12 to C24 fatty acids, C14 to C22 fatty acids. C16 to C20 fatty acids, and especially C18 fatty acids. Thus, the resulting dimer fatty acids include from 20 to 60, 24 to 48, 28 to 44, 32 to 40, and especially 36 carbon atoms.

The fatty acids used to form the dimer fatty diols may be selected from linear, branched, or cyclic fatty acids, which may be saturated or unsaturated. The unsaturated fatty acids may be selected from fatty acids having either a cis/trans configuration, and may have one or more than one unsaturated double bond. In some embodiments, the fatty acids used are linear monounsaturated fatty acids. The fatty acids may be hydrogenated or non-hydrogenated, and in some cases a hydrogenated dimer fatty residue may have better oxidative or thermal stability which may be desirable in a polyurethane.

In some embodiments, suitable dimer fatty acids can be the dimerization products of fatty acids including, but not limited to, oleic acid, linoleic acid, linolenic acid, palmitoleic acid, or elaidic acid. In particular, suitable dimer fatty acids are derived from oleic acid. The dimer fatty acids may be dimerization products of unsaturated fatty acid mixtures obtained from the hydrolysis of natural fats and oils, e.g. sunflower oil, soybean oil, olive oil, rapeseed oil, cottonseed oil, or tall oil.

In various embodiments, the molecular weight (weight average) of the dimer fatty acids used to make the TPU polymer described herein is 450 to 690, or 500 to 640, or 530 to 610, or 550 to 590.

In addition to the dimer fatty acids, dimerization usually results in varying amounts of trimer fatty acids, oligomeric fatty acids, and residues of monomeric fatty acids, or esters thereof, being present. In various embodiments, the dimer fatty acid used to make the dimer fatty diol should have a relatively low amount of these additional dimerization products, and the dimer fatty acid should have a dimer fatty acid (or dimer) content of greater than 80 wt %, or greater than 85 wt %, or greater than 90 w % t %, or greater than 95 wt %, or up to 99 wt %, based on the total weight of polymerized fatty acids and mono fatty acids present.

Any of the above dimer fatty acid may be converted to a dimer fatty diol, and the resulting dimer fatty diol may have the properties of the dimer fatty acids described herein, except that the acid groups in the dimer fatty acid are replaced with hydroxyl groups in the dimer fatty diol. The dimer fatty diol may be hydrogenated or non-hydrogenated.

In some embodiments, which are not intended to be limiting, the dimer fatty diol is derived from a fatty acid with a C18 alkyl chain. In one embodiment, the dimer fatty diol is a C36 diol available from Croda, Inc., New Castle, Del., under the trade designation PRIPOL 2033. One depiction of the structure of PRIPOL 2033 is shown below:

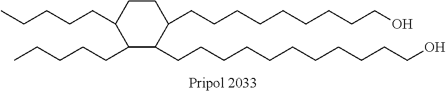 [SMILES: CCCCCC1CCC(CCCCCCCCCO)C(CCCCCCCCCCCO)C1CCCCC]

The polyisocyanate reactant used to make the TPU polymer includes at least one isocyanate with a functionality of at least 2, and in various embodiments may be an aliphatic isocyanate, such as hexamethylene 1,6-diisocyanate or isophorone diisocyanate (IPDI), or an aromatic isocyanate.

In some embodiments, the polyisocyanate is a an aromatic isocyanate, and suitable examples include, but are not limited to, toluene diisocyanate, m-phenylene diisocyanate, p-phenylene diisocyanate, xylylene diisocyanate, 4,4′-diphenylmethane diisocyanate, hexamethylene diisocyanate, isophorone diisocyanate, polymethylenepolyphenyl diisocyanate, 3,3′-dimethyl-4,4′-biphenylene diisocyanate, 3,3′-dimethyl-4,4′-diphenylmethane diisocyanate, 3,3-dichloro-4,4′-biphenylene diisocyanate, 1,5-naphthalene diisocyanate, modified compounds thereof such as uretonimine-modified compounds thereof, and mixtures and combinations thereof.

In one embodiment, the isocyanate component includes 4,4′-diphenylmethane diisocyanate (MDI), or a mixture of MDI and a uretonimine-modified 4,4′-diphenylmethane diisocyanate (modified MDI).

The optional hydroxyl-functional chain extender has two or more active hydrogen groups and in some embodiments includes polyols such as ethylene glycol, diethylene glycol, propylene glycol, 1,4-butylene glycol, 1,5-pentylene glycol, methylpentanediol, isosorbide (and other iso-hexides), 1,6-hexylene glycol, neopentyl glycol, trimethylolpropane, hydroquinone ether alkoxylate, resorcinol ether alkoxylate, glycerol, pentaerythritol, digylcerol, and dextrose; dimer fatty diol, aliphatic polyhydric amines such as ethylenediamine, hexamethylenediamine, and isophorone diamine; aromatic polyhydric amines such as methylene-bis(2-chloroaniline), methylenebis(dipropylaniline), diethyl-toluenediamine, trimethylene glycol di-p-aminobenzoate; alkanolamines such as diethanolamine, triethanolamine, diisopropanolamine, and mixtures and combinations thereof.

In various embodiments the hydroxyl-functional chain extender is a polyol, particularly a diol with an aliphatic linear or branched carbon chain having from 1 to 10, or 3 to 7 carbon atoms. Suitable diols include, but are not limited to, ethylene glycol, propylene glycol, diethylene glycol, propylene glycol, 1,4-butylene glycol, 1,5-pentylene glycol, 1,6 hexylene glycol (1,6 hexane diol), methylpentanediol, isosorbide (and other iso-hexides), and mixtures and combinations thereof.

In some embodiments, other optional additives may be incorporated into the TPU polymer such as, for example, blowing agents, urethane promoting catalysts, pigments, fillers, blowing agents, surfactants, crosslinkers, antimicrobial compounds, and stabilizers.

Suitable blowing agents include water, and fluorocarbons such as trichlorofluoromethane, dichlorodifluoromethane and trichlorodifluoroethane, and mixtures and combinations thereof.

Examples of urethane catalysts include tertiary amines such as triethylamine, 1,4-diazabicyclo[2.2.2.]octane (DABCO), N-methylmorpholine, N-ethylmorpholine, N,N,N′,N′-tetramethylhexamethylenediamine, 1,2-dimethylimidazol; and tin compounds such as tin(II)acetate, tin(II)octanoate, tin(II)laurate, dibutyltin dilaurate, dibutyltin dimaleate, dioctyltin diacetate, dibutyltin dichloride, and mixtures and combinations thereof.

Suitable surfactants include silicone surfactants such as dimethylpolysiloxane, polyoxyalkylene polyol-modified dimethylpolysiloxane and alkylene glycol-modified dimethylpolysiloxane; and anionic surfactants such as fatty acid salts, sulphuric acid ester salts, phosphoric acid ester salts and sulphonates.

Examples of the stabilizers include hindered phenol radical scavengers such as dibutylhydroxytoluene, pentaerythrityl-tetrakis[3-(3,5-di-t-butyl-4-hydroxyphenyl) propionate] and isooctyl-3-(3,5-di-t-butyl-4-hydroxyphenyl)propionate; antioxidants such as phosphorous acid compounds such as triphenylphosphite, triethylphosphite and triphenylphosphine; ultraviolet absorbing agents such as 2-(5-methyl-2-hydroxyphenyl)benzotriazole and a condensation product of methyl-3-[3-t-butyl-5-(2H-benzotriazole-2-yl)-4-hydroxyphenyl]propionate and polyethylene glycol.

Suitable pigments include inorganic pigments such as transition metal salts; organic pigments such as azo compounds; and carbon powder. Suitable fillers include inorganic fillers such as clay, chalk, and silica.

Suitable crosslinkers include, but are not limited to, vinyl diols having the formula HX—R—XH; and wherein X is O, S, NH or NR1, where R1 is an alkylene group including 1 to 4 carbon atoms; and R is an organic vinyl linking group and includes 1 to 50 carbon atoms. In some embodiments, which are not intended to be limiting, the vinyl diols optionally include one or more tertiary nitrogen, ether oxygen, or ester oxygen atoms, and are free from isocyanate-reactive hydrogen containing groups. In one example embodiment, which is not intended to be limiting, suitable vinyl diols include trimethylolpropane allyl ether, 3-vinyl-5-hexene-1,2-diol, 3-vinyl-4-pentene-2,3-diol, 6-vinyl-octene-1,5-diol, allyloxy-1,2-propanediol, and mixtures and combinations thereof.

In some embodiments, which are not intended to be limiting, the antimicrobial compounds are chosen from antimicrobial lipids consisting of a (C7-C12) saturated fatty acid ester of a polyhydric alcohol (preferably, a (C8-C12) saturated fatty acid ester of a polyhydric alcohol), an (C8-C22) unsaturated fatty acid ester of a polyhydric alcohol (preferably, an (C12-C22) unsaturated fatty acid ester of a polyhydric alcohol), a (C7-C12) saturated fatty ether of a polyhydric alcohol (preferably, a (C8-C12) saturated fatty ether of a polyhydric alcohol), an (C8-C22) unsaturated fatty ether of a polyhydric alcohol (preferably, an (C12-C22) unsaturated fatty ether of a polyhydric alcohol), an alkoxylated derivative thereof, and combinations thereof. In some embodiments, the esters and ethers are monoesters and monoethers, unless they are esters and ethers of sucrose in which case they can be monoesters, diesters, monoethers, or diethers. Various combinations of monoesters, diesters, monoethers, and diethers can be used.

In some embodiments, the (C7-C12) saturated and (C8-C22) unsaturated monoesters and monoethers of polyhydric alcohols can be at least 80% pure (having 20% or less diester and/or triester or diether and/or triether), more preferably 85% pure, even more preferably 90% pure, most preferably 95% pure. Impure esters or ethers would not have sufficient, if any, antimicrobial activity.

Useful fatty acid esters of a polyhydric alcohol may have the formula:

(R¹—C(O)—O)ₙ—R²

wherein R¹ is the residue of a (C7-C12) saturated fatty acid (preferably, a (C8-C12) saturated fatty acid), or a (C8-C22) unsaturated (preferably, a C12-C22) unsaturated, including polyunsaturated) fatty acid, R² is the residue of a polyhydric alcohol (typically and preferably, glycerin, propylene glycol, and sucrose, although a wide variety of others can be used including pentaerythritol, sorbitol, mannitol, xylitol, etc.), and n=1 or 2. The R² group includes at least one free hydroxy 1 group (preferably, residues of glycerin, propylene glycol, or sucrose). Preferred fatty acid esters of polyhydric alcohols are esters derived from C7, C8, C9, C10, C11, and C12 saturated fatty acids. For embodiments in which the polyhydric alcohol is glycerin or propylene glycol, n=1, although when it is sucrose, n=1 or 2. In general, monoglycerides derived from C10 to C12 fatty acids are food grade materials and GRAS materials.

Fatty acid esters are particularly useful candidates for treating surfaces exposed to microbes and pathogens such as those present in the oral environment. Many of the monoesters have been reported to be food grade, generally recognized as safe (GRAS) materials. For example, Kabara, J. of Food Protection. 44:633-647 (1981) and Kabara, J. of Food Safety. 4:13-25 (1982) report that LAURICIDIN (the glycerol monoester of lauric acid commonly referred to as monolaurin), a food grade phenolic and a chelating agent may be useful in designing preservative systems.

Fatty acid monoesters, such as glycerol monoesters of lauric, caprylic, capric, and heptanoic acid and/or propylene glycol monoesters of lauric, caprylic, capric and heptanoic acid, are active against Gram positive bacteria, fungi, yeasts and lipid coated viruses but alone are not generally active against Gram negative bacteria.

Exemplary fatty acid monoesters include, but are not limited to, glycerol monoesters of lauric (monolaurin), caprylic (monocaprylin), and capric (monocaprin) acid, and propylene glycol monoesters of lauric, caprylic, and capric acid, as well as lauric, caprylic, and capric acid monoesters of sucrose. Other fatty acid monoesters include glycerin and propylene glycol monoesters of oleic (18:1), linoleic (18:2), linolenic (18:3), and arachonic (20:4) unsaturated (including polyunsaturated) fatty acids. As is generally known, 18:1, for example, means the compound has 18 carbon atoms and 1 carbon-carbon double bond. Preferred unsaturated chains have at least one unsaturated group in the cis isomer form. In certain preferred embodiments, the fatty acid monoesters that are suitable for use in the present composition include known monoesters of lauric, caprylic, and capric acid, such as that known as GML or the trade designation LAURICIDIN (the glycerol monoester of lauric acid commonly referred to as monolaurin or glycerol monolaurate), glycerol monocaprate, glycerol monocaprylate, propylene glycol monolaurate, propylene glycol monocaprate, propylene glycol monocaprylate, and combinations thereof.

In various embodiments, which are not intended to be limiting, the TPU polymer has a stoichiometric ratio of isocyanate to hydroxyl groups ranging from about 0.75:1 to about 1.25:1.

In some embodiments, the TPU polymer may be formed in a dispersion and cast into a film, or applied on a mold with tooth-receiving cavities. However, the TPU polymer may most conveniently be prepared by a reactive extrusion process in which a polymeric reactive extrusion composition including the polyisocyanate, at least one dimer fatty diol, the optional hydroxyl-functional chain extender, and any other optional components such as crosslinkers, catalysts, and the like are loaded into an extruder and extruded from an appropriate die to form a film. In some embodiments, the film may later be thermoformed into a dental appliance with tooth-retaining cavities. In another embodiment, the reactive extrusion composition may be injected into a mold, which in some cases may include tooth-retaining cavities.

In the extruder the TPU polymer is formed as the reaction product of the polyisocyanate, at least one dimer fatty diol, and the optional hydroxyl-functional chain extender. In some embodiments, the polyisocyanate and the chain extender, if present, are first reacted together to form a prepolymeric composition, which is then reacted in the extruder with the dimer fatty diol and optional components to form the film with the TPU polymer.

An example of a typical reaction scheme is shown below. In this embodiment, which is not intended to be limiting, a reactive extrusion composition including diisocyanate MONDUR MB (4,4′-diphenylmethane diisocyanate (MDI)), a chain extender of 1.6 hexane diol, and a C36 dimer fatty diol PRIPOL 2033 are reacted in the extruder with heat at a temperature of less than about 175° C., and in the absence of a catalyst, to form a TPU polymer. The TPU polymer includes monomeric units derived from the diisocyanate, the chain extender and the dimer fatty diol, with the chain extender segments between the segments derived from the diisocyanate.

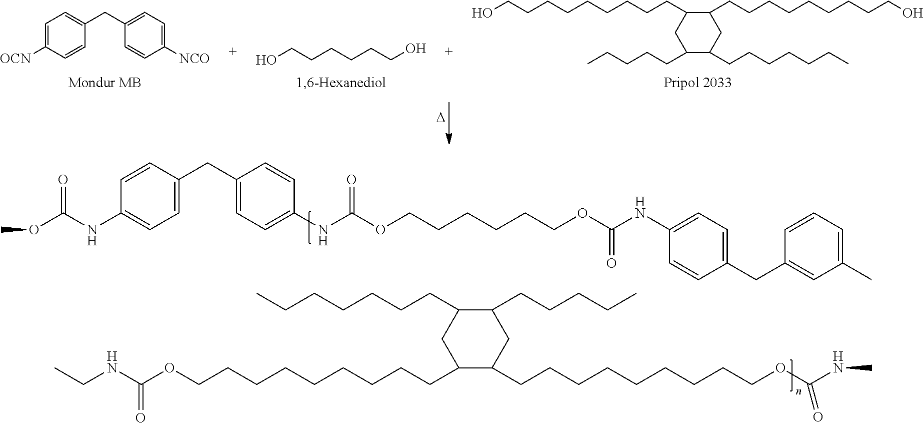

In some embodiments, the composition including the polyisocyanate, at least one dimer fatty diol, the optional hydroxyl-functional chain extender, and any additional optional components such as crosslinkers, catalysts, and the like is reactively extruded at a temperature of less than about 200° C. or less than about 175° C., or less than about 170° C., or less than about 150° C., or less than about 140° C. (±5° C.) without a catalyst. The relatively low temperature used in the reactive extrusion process, as well as the lack of catalytic by-products, effectively reduces or eliminates free isocyanates and low molecular weight species in the film, which can improve patient safety when the film is later formed into a dental appliance. For example, in some embodiments, which are not intended to be limiting, the dental appliance with a layer including the TPU composition of the present disclosure has a residual isocyanate content of less than about 50 ppm, or less than about 10 ppm, or less than about 5 ppm.

In some example embodiments, which are not intended to be limiting, the polymeric reactive extrusion composition includes about 20 wt % to about 80 wt % of the polyisocyanate, or about 30 wt % to about 60 wt %, about 5 wt % to about 70 wt % of the dimer fatty diol, or about 15 wt % to about 30 wt %, about 0 wt % to about 35 wt % of the chain extender, or about 10 wt % to about 20 wt %, up to about 5 wt % of the optional crosslinker, up to about 5 wt % of the optional antimicrobial compound, and up to about 5 wt % of other optional components.

The extruded film may optionally be crosslinked with radiation chosen from ebeam, gamma, UV, and mixtures and combinations thereof.

In various embodiments, the extruded film has a thickness of less than about 1 mm, or less than about 0.8 mm, or less than about 0.5 mm.

In some embodiments, the extruded film may be manufactured in a roll-to-roll manufacturing process, and may optionally be wound into a roll until further converting operations are required.

In various non-limiting embodiments that are included for the purposes of illustration, the TPU film can also be used as an optical film in optical and display devices with tunable refractive index by adjusting the monomeric compositions. The TPU film also has good mechanical properties and weathering resistance and can therefor be used in window and solar film applications.

In some embodiments, the TPU polymer may be coextruded with another polymeric film, or extruded onto an existing polymeric film, to form a multilayered polymeric film construction. The multilayered polymeric film construction may include one or multiple layers of the TPU polymer. The polymers in the layers of the multilayered film construction may be selected to provide particular properties to the multilayered film or a dental appliance to be formed therefrom including, but not limited to, resistance to moisture absorption, resistance to staining, desired optical properties such as, for example, color, visible light transmission, and haze, ease of release from a thermoforming mold, and resistance to cracking following repeated placement over the teeth of the patient.

For example, in some embodiments, the TPU polymer may be formed into a multilayered polymeric film construction with at least one other thermoplastic polymer having a flexural modulus of about 1.0 GPa to about 4.0 GPa, 1 GPa to about 3 GPa, or about 1.25 GPa to about 2 GPa, and a Vicat softening temperature greater than about 40° C. and up to about 200° C., about 50° C. to about 200° C., or about 70° C. to about 170° C., or about 75° C. to about 150° C.

In various embodiments, which are not intended to be limiting, suitable thermoplastic polymers for the multilayered film construction arm chosen from polyesters and copolyesters, which may include linear, branched or cyclic segments on the polymer backbone. Suitable materials include, but are not limited to, polyethylene terephthalate (PET), polyethylene terephthalate glycol (PETg), polycyclohexylenedimeLhylene terephthalate (PCT), polycyclohexylenedimethylene terephthalate glycol (PCTg), polycarbonate (PC), copolyesters, and mixtures and combinations thereof. Suitable PETg and PCTg resins can be obtained from various commercial suppliers such as, for example. Eastman Chemical, Kingsport, Tenn.; SK Chemicals, Irvine, Calif.; DowDuPont, Midland, Mich.; Pacur, Oshkosh, Wis.: and Scheu Dental Tech, Iserlohn, Germany. For example, EASTAR GN071 PETg resins and PCTg VM318 resins from Eastman Chemical have been found to be suitable. Suitable polycarbonates (PC) can be obtained from, for example, Covestro AG, Baytown, Tex., under the trade designation MAKROLON LTG2623. Suitable polyester and PC blends include, but are not limited to, resins available under the trade designation XYLEX from Sabic, Exton, Pa., such as XYLEX X8519. Suitable copolyesters include, but are not limited to, those available under the trade designation TRITAN from Eastman Chemical.

In one embodiment, the polymeric layers used in the multilayered film construction along with the TPU polymer include PETg. PCTg, PC, copolyester, and mixtures and combinations thereof.

In some embodiments, the extruded multilayered film construction, or any layer thereof, may optionally be crosslinked with radiation chosen from ebeam, gamma, UV, and mixtures and combinations thereof.

In some embodiments, the extruded multilayered film may be manufactured in a roll-to-roll manufacturing process, and may optionally be wound into a roll until further converting operations are required.

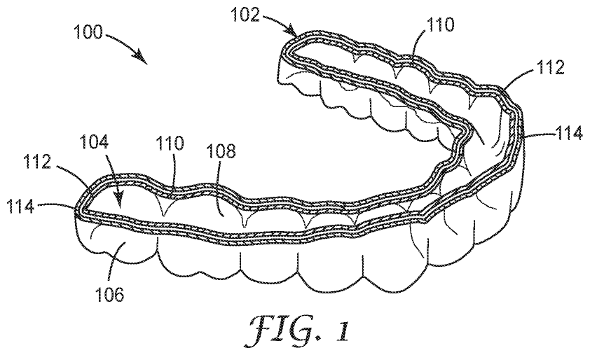

In some embodiments, the extruded single-layer or coextruded multi-layered films including a least one layer with the TPU polymer may be thermoformed into a dental appliance such as, for example, an orthodontic aligner tray, an orthodontic retainer tray, a temporary bridge, or a surgical splint. For example, the single or multilayered TPU polymer-containing film constructions may be formed into an orthodontic appliance 100 shown in FIG. 1, also referred to herein as an orthodontic aligner tray, which includes a thin polymeric shell 102 having a plurality of cavities 104 shaped to receive one or more teeth in the upper or lower jaw of a patient. In some embodiments, m the orthodontic aligner tray 100 the cavities 104 are shaped and configured to apply force to the teeth of the patient to resiliently reposition one or more teeth from one tooth arrangement to a successive tooth arrangement. In the case of a retainer tray, the cavities 104 arm shaped and configured to receive and maintain the position of one or more teeth that have previously been aligned.

In some embodiments, the single layer or multilayered polymeric film is heated prior to forming the tooth-retaining cavities, or a surface thereof may optionally be chemically treated such as, for example, by etching, or mechanically embossed by contacting the surface with a tool, prior to or after forming the cavities.

In various embodiments, thermoformed single layer TPU polymer-containing dental appliances had an excellent combination of properties such as, for example, any or all of: a tensile modulus of about 0.8 to about 2.0 GPa, or about 1.0 GPa to about 1.5 GPa, a coffee stain index of less than about 3, or less than about 2, and a peg board wet-dry deflection of less than about 0.1, or less than about 0.05, or less than 0.03, as measured after 7 days of aging at 37° C.

In the particular embodiment of FIG. 1, the shell 102 includes at least three alternating polymeric layers including polymers AB, wherein layer A includes the TPU polymer described above, and B is another thermoplastic polymer described above and selected to, for example, provide or maintain a sufficient and substantially constant stress profile during a desired treatment time, to provide a relatively constant tooth repositioning force over the treatment time to maintain or improve the tooth repositioning efficiency of the shell 102, to provide a moisture resistant barrier layer, to provide a stain-resistant barrier layer, and the like.

In the embodiment of FIG. 1, a polymeric layer 114 forms an external surface 106 of the shell 102, a polymeric layer 110 forms an internal surface 108 of the shell 102, and a polymeric layer 112 resides between the polymeric layers 110 and 114. The polymeric layers 110, 112, 114 each include layers of thermoplastic polymeric materials A or B. The thermoplastic polymeric materials in the layers 110, 112, 114 are arranged to alternate such as, for example, in the arrangement ABA or BAB. For example, in the embodiment of FIG. 1, the layer 110 can include polymer A, the layer 114 can include polymer A. and the layer 112 can include polymer B. Or, the layer 110 can include polymer B, the layer 114 can include polymer A, and the layer 112 can include polymer B.

In some embodiments, the layer 114 on the outer major surface 106 of the dental appliance 100 and the layer 110 on the inner surface 108 include the same polymeric layer A or B. In other embodiments, the layer 110 on the outer major surface 106 of the dental appliance 100 and the layer 114 on the inner surface 108 include different polymeric layers A and B.

In some embodiments, the polymers B in the each of the layers 110, 112, 114 of the polymeric shell 102 are polyesters, and in some embodiments the polyester in a particular layer may optionally be blended with a polycarbonate (PC). In various embodiments, suitable polymers B in the polymeric shell 102 include, but are not limited to, polyethylene terephthalate glycol (PETg), polycyclohexylenedimethylene terephthalate (PCT), polycyclohexylenedimethylene terephthalate glycol (PCTg), polycarbonate (PC), copolyesters such as TRITAN, and mixtures and combinations thereof.

As discussed above, in some embodiments any or all the layers AB in the polymeric shell 102 may optionally include an antimicrobial compound such as, for example, monolaurin. In some embodiments, the shell 102 may include a coating of an antimicrobial compound monolaurin, a coating of a metal oxide, or a combination thereof, to provide an enhanced antimicrobial effect alone or in combination with the antimicrobial compound in the polymeric layers AB.

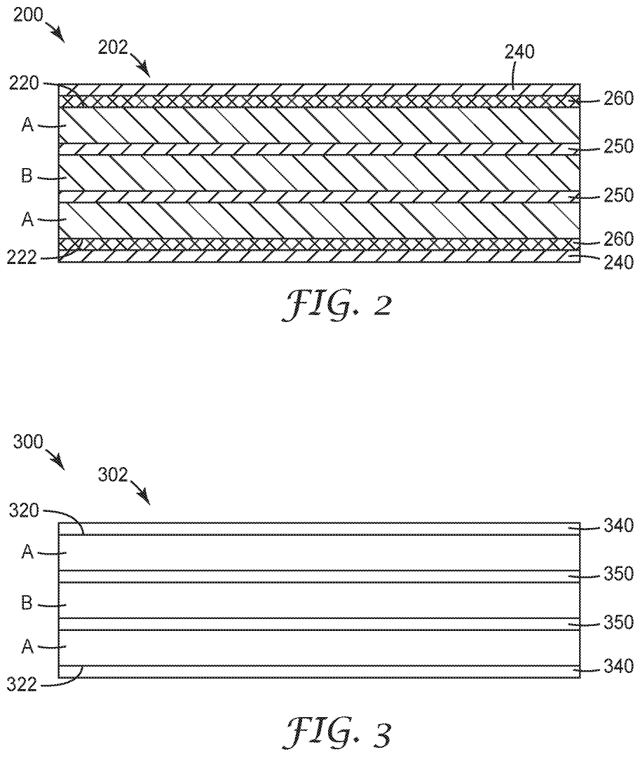

A schematic cross-sectional view of another embodiment of a dental appliance 200 is shown in FIG. 2, which includes a polymeric shell 202 with a multilayered polymeric structure. The polymeric shell 202 includes three alternating layers including thermoplastic polymers AB, and includes the same layer A proximal a first major surface 220 and a second major surface 222. The layer A includes the TPU-containing polymer described herein, and the layer B includes any of the thermoplastic polymers B discussed with respect to FIG. 1, which maintain a substantially constant stress profile during a treatment time, provide a relatively constant tooth repositioning force over the treatment time to maintain or improve tooth repositioning efficiency, resist staining, and resist moisture absorption.

In the embodiment of FIG. 2, the polymeric shell 202 further includes additional optional performance enhancing layers that can be included to improve properties of the shell 202. In various embodiments, which are not intended to be limiting, the performance enhancing layers can be, for example, barrier layers that are resistant to staining and moisture absorption; abrasion-resistant layers; cosmetic layers that may optionally include a colorant, or may include a polymeric material selected to adjust the optical haze or visible light transparency of the polymeric shell 202; the layers that enhance compatibility or adhesion between packets of layers AB or between layers AB in each packet, elastic layers to provide a softer mouth feel for the patient; thermal forming assistant layers between packets of layers AB or between layers AB in each packet to enhance thermoforming, layers to enhance mold release during thermoforming, and the like.

The performance enhancing layers may include a wide variety of polymers selected to provide a particular performance benefit, but the polymers in the performance enhancing layers are generally selected from materials that are softer and more elastic that the polymers AB. In various embodiments, which are not intended to be limiting, the performance enhancing layers include thermoplastic polyurethanes (TPU) and olefins.

In some non-limiting examples, the olefins in the performance enhancing layers are chosen from polyethylene (PE), polypropylene (PP), polymethylpentene (PMP), cyclic olefins (COP), copolyolefins with moieties chosen from ethylene, propylene, butene, pentene, hexene, octene, C2-C20 hydrocarbon monomers with polymerizable double bonds, and mixtures and combinations thereof; and olefin hybrids chosen from olefin/anhydride, olefin/acid, olefin/styrene, olefin/acrylate, and mixtures and combinations thereof.

For example, in the embodiment of FIG. 2, the polymeric shell 202 includes an optional moisture barrier layer 240 on each external surface, which can prevent moisture intrusion into the polymeric layers AB, and maintain for the shell 202 a substantially constant stress profile during a treatment time. The polymeric shell 202 further includes tie or thermoforming assist layers 250, which can be the same or different, between individual layers AB in each packet of alternating layers. In some embodiments, the tie/thermoforming assist layers 250 can improve compatibility between the polymers in the layers AB as the polymeric shell 202 is formed from a multilayered polymeric film, or reduce delamination between layers AB and improve the durability and crack resistance of the polymeric shell 202 over an extended treatment time. The polymeric shell 202 in FIG. 2 further includes elastic layers 260, which can be the same or different, and can be included to improve the softness or mouth feel of the shell 202. In the embodiment of FIG. 2, the elastic layers 260 are located proximal the major surfaces 220, 222 of the shell 202.

A schematic cross-sectional view of another embodiment of a dental appliance 300 is shown in FIG. 3, which includes a polymeric shell 302 with a multilayered polymeric structure. The polymeric shell includes alternating layers of thermoplastic polymers AB, and includes a different layer proximal a first major surface 320 and a second major surface 322. The layers AB can be selected from any of the thermoplastic polymers A and B discussed above with respect to FIGS. 1-2.

In the embodiment of FIG. 3, the polymeric shell 302 includes a moisture barrier and stain resistant layer 340 on each external surface, which can prevent intrusion of moisture into the polymeric layers AB and reduce damage to the shell 302 from colored foods (for example, tea, coffee, red wine and the like). The polymeric shell 302 further includes tie or thermoforming assistant layers 350, which can be the same or different, between each packet of alternating layers AB. In some embodiments, the layers 350 can improve compatibility between the polymers in the layers AB as the polymeric shell 302 is formed from a multilayered polymeric film, or reduce delamination between layers AB during the treatment time.

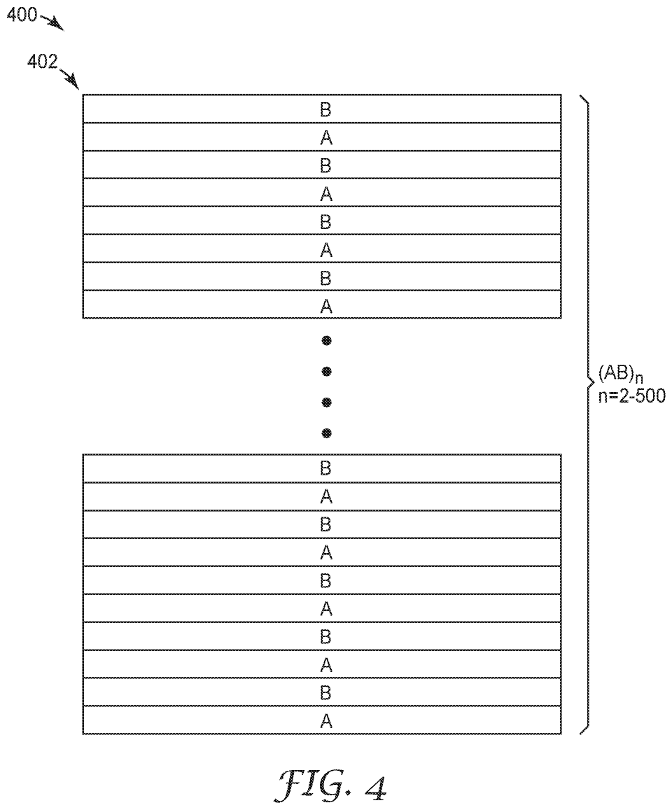

A schematic cross-sectional view of another embodiment of a dental appliance 400 is shown in FIG. 4, which includes a polymeric shell 402 with a multilayered polymeric structure (AB)ₙ, wherein n=2 to about 500, or about 5 to about 200, or about 10 to about 100. The layers A include the TPU polymer described herein, and the layers B can be selected from any of the thermoplastic polymers discussed above with respect to FIGS. 1-3.

Referring again to FIG. 1, in some embodiments, the polymeric shell 102 is formed from substantially transparent polymeric materials. In this application the term substantially transparent refers to materials that pass light in the wavelength region sensitive to the human eye (about 400 nm to about 750 nm) while rejecting light in other regions of the electromagnetic spectrum. In some embodiments, the reflective edge of the polymeric materials selected for the shell 102 should be above about 750 nm, just out of the sensitivity of the human eye.

In some embodiments, any or all of the layers of the polymeric shell 102 can optionally include dyes or pigments to provide a desired color that may be, for example, decorative or selected to improve the appearance of the teeth of the patient.

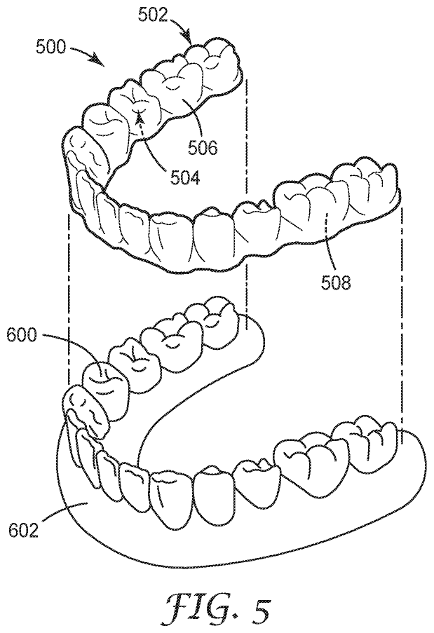

Referring now to FIG. 5, a shell 502 of an orthodontic appliance 500 includes an outer surface 508 and an inner surface 508 with cavities 504 that generally conform to one or more of a patient's teeth 600, and an external surface 506. In some embodiments, the cavities 504 are slightly out of alignment with the patient's initial tooth configuration, and in other embodiments the cavities 504 conform to the teeth of the patient to maintain a desired tooth configuration. In some embodiments, the shell 502 may be one of a group or a series of shells having substantially the same shape or mold, but which are formed from different materials to provide a different stiffness or resilience as need to move the teeth of the patient. In some embodiments, the shell 502 may be one of a group or a series of shells having different shapes or molds, but which are formed from the same materials to provide a different stiffness or resilience as need to move the teeth of the patient. In this manner, in one embodiment, a patient or a user may alternately use one of the orthodontic appliances during each treatment stage depending upon the patient's preferred usage time or desired treatment time period for each treatment stage.

No wires or other means may be provided for holding the shell 502 over the teeth 600, but in some embodiments, it may be desirable or necessary to provide individual anchors on teeth with corresponding receptacles or apertures in the shell 502 so that the shell 502 can apply a retentive or other directional orthodontic force on the tooth which would not be possible in the absence of such an anchor.

The shells 502 may be customized, for example, for day time use and night time use, during function or non-function (chewing vs. non-chewing), during social settings (where appearance may be more important) and nonsocial settings (where the aesthetic appearance may not be a significant factor), or based on the patient's desire to accelerate the teeth movement (by optionally using the more stiff appliance for a longer period of time as opposed to the less stiff appliance for each treatment stage).

For example, in one aspect, the patient may be provided with a clear orthodontic appliance that may be primarily used to retain the position of the teeth, and an opaque orthodontic appliance that may be primarily used to move the teeth for each treatment stage. Accordingly, during the day time, in social settings, or otherwise in an environment where the patient is more acutely aware of the physical appearance, the patient may use the clear appliance. Moreover, during the evening or night time, in non-social settings, or otherwise when in an environment where physical appearance is less important, the patient may use the opaque appliance that is configured to apply a different amount of force or otherwise has a stiffer configuration to accelerate the teeth movement during each treatment stage. This approach may be repeated so that each of the pair of appliances are alternately used during each treatment stage.

Referring again to FIG. 5, an orthodontic treatment system and method includes a plurality of incremental position adjustment appliances, each formed from the same or a different material, for each treatment stage of orthodontic treatment. The orthodontic appliances may be configured to incrementally reposition individual or multiple teeth 600 in an upper or lower jaw 602 of a patient. In some embodiments, the cavities 504 are configured such that selected teeth will be repositioned, while other teeth will be designated as a base or anchor region for holding the repositioning appliance in place as the appliance applies the resilient repositioning force against the tooth or teeth intended to be repositioned.

Placement of the elastic positioner 502 over the teeth 600 applies controlled forces in specific locations to gradually move the teeth into the new configuration. Repetition of this process with successive appliances having different configurations eventually moves the teeth of a patient through a series of intermediate configurations to a final desired configuration.

The devices of the present disclosure will now be further described in the following non-limiting examples.

### EXAMPLES

Materials

MDI: 4,4′-diphenylmethane diisocyanate (MDI) from Covestro, Pittsburgh, Pa. under tradename MONDUR MB
PRIPOL 2033: C36 diol from Croda, Inc., New Castle, Del.
1,6 hexane diol: chain extender from Alfa Aesar, Ward Hill, Mass. trimethylolpropane allyl ether: crosslinking agent from Sigma-Aldrich, St. Louis, Mo.
TPU disk ZENDURA from Bay Materials, LLC, Fremont, Calif.
Trilayer INVISALIGN alignment tray from Align Technology, San Jose, Calif.
10 mil TRITAN film is obtained from Pacur, LLC., Oshkosh, Wis.

### Summary of Test Procedures

The following test procedures were used in the examples below.

### Tensile Modulus

Tensile modulus was tested according to ASTM D638. The dogbone shaped specimen made by die cutting was placed in the grips of a universal testing machine. The initial slope of the stress-strain curve was then utilized to determine the tensile modulus.

### Coffee Stain Color Index

Coffee was used for the stain test. The sample was soaked in the coffee for 72 hours at 37° C. The resulting color change (DE) was measured before and after soaking using X-Rite 3M Inst. No. 1528196. If the color change (DE) was larger than 10, the sample was rated as poor (−−). If the color change (DE) was less than 10, the sample was rated as Good (++).

### Peg Board Dry Deflection

The peg board test provides a strain controlled situation where a 0.762 mm thick film will experience a maximum strain of 2% on the outer surface of the film due to bending. Assuming a circular arc (pure bending), this was achieved by spacing 3.175 mm diameter pegs 17.50 mm apart. A film sample was cut into a strip and woven between 5 of these pegs. The sample was held in place by the pegs for 7 days at 37° C. in an oven. Then the total plastic deformation was measured by removing the sample and examining its shape relative to the maximum deformation possible in the test.

### Peg Board Wet Deflection

The peg board test provides a strain controlled situation where a 0.762 mm thick film will experience a maximum strain of 2% on the outer surface of the film due to bending. Assuming a circular arc (pure bending), this was achieved by spacing 3.175 mm diameter pegs 17.50 mm apart. A film sample was cut into a strip and woven between 5 of these pegs. The sample was held in place by the pegs for 7 days immersed in water at 37° C. Then the total plastic deformation was measured by removing the sample and examining its shape relative to the maximum deformation possible in the test.

### Example 1

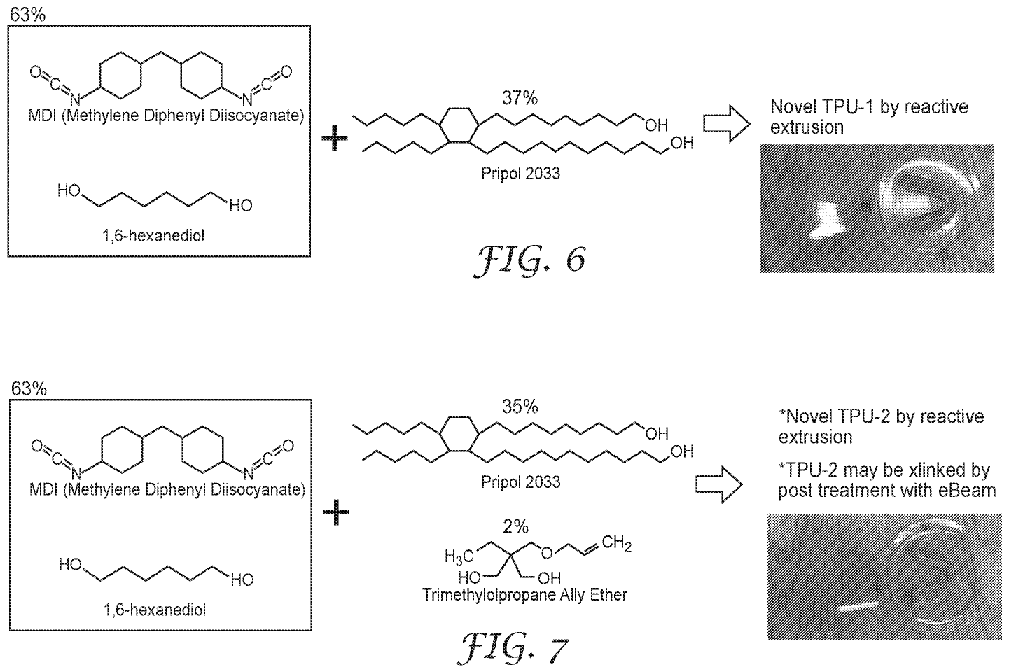

A 30 mil (0.76 mm) single layer film sheet was made by reactive extrusion of Composition 1 shown schematically in FIG. 6 using twin screw extruder at 170° C. Composition 1 included 63 wt % of a prepolymer mixture including MDI and 1,6 hexane diol, and 37 wt % of PRIPOL 2033, based on the total weight of the composition. The extruded sheet was chilled on a cast roll. The overall sheet thickness was controlled at 30 mils (0.76 mm). The single-layer film sample was wound into a roll.

A portion of the extruded sheet was die cut and thermoformed into an aligner tray. The die cut disk and thermoformed tray are also displayed in FIG. 6.

### Example 2

A 30 mil (0.76 mm) single layer film sheet was made by reactive extrusion of Composition 2 shown schematically in FIG. 7 using twin screw extruder at 140° C. Composition 2 included 63 wt % of a prepolymer mixture including MDI and 1,6 hexane diol, 35 wt % of PRIPOL 2033, and 2 wt % of a trimethylolpropane allyl ether crosslinking agent, based on the total weight of the composition. The extruded sheet was chilled on a cast roll. The overall sheet thickness was controlled at 30 mils (0.76 mm). The 3-layer film sample was wound into a roll.

A portion of the extruded sheet was die cut and thermoformed into an aligner tray. The die cut disk and thermoformed tray are also displayed in FIG. 7.

### Example 3

A 30 mil (0.76 mm) single layer film sheet was made by reactive extrusion of Composition 1 shown schematically in FIG. 6 using twin screw extruder at 170° C. Composition 1 included 63 wt % of a prepolymer mixture including MDI and 1,6 hexane diol, and 37 wt % of PRIPOL 2033, based on the total weight of the composition. The extruded sheet with a sheet thickness of 10 mils (0.25 mm) was extruded between two 10 mil Tritan film, then pressed to obtain 30 mil 3-layer film sheet. The peg board dry deflection of the trilayer film was determined to be 3.51 mm and 3.82 mm for the wet deflection. The difference between dry and wet peg board deflections was 0.31 mm.

### Comparative Example 1

A TPU disk available under the trade designation ZENDURA from Bay Materials, LLC, Fremont, Calif., was obtained for comparative testing.

### Comparative Example 2

A 3-layer INVISALIGN dental alignment tray from Align Technology, San Jose, Calif., was obtained for comparative testing.

The comparative test results for the test procedures described above are shown in Table 1 below:

TABLE 1

| | | | Comparative | Comparative | |
|---|---|---|---|---|---|
| Properties | Example 1 | Example 2 | Example 1 | Example 2 | Comment |
| Tensile | 1.42 GPa | 1.47 GPa | 1.72 GPa | 0.97 GPa | Optimal Zone: 0.8-1.5 |
| Modulus | | | | | GPa |
| Coffee stain | 2.4 | 1.9 | 1.1 | 45.3 | <3 is considered |
| color index | | | | | excellent |
| Peg Board Dry | 3.93 | 3.82 | 3.38 | N/A | |
| (37° C.) | (7 days | (7 days | (1 day aged) | | |
| | aged) | aged) | | | |
| Peg Board Wet | 4 | 3.85 | 4.01 | N/A | Wet = sample |
| (37° C.) | (7 days | (7 days | (1 day aged) | | immersed in water |
| | aged) | aged) | | | |
| Peg Board Wet- | 0.07 | 0.03 | 0.63 | N/A | Lower value is better, |
| Dry (37° C.) | (7 days | (7 days | (1 day aged) | | “zero” indicates no |
| | aged) | aged) | | | difference between |
| | | | | | dry vs. wet (impact |
| | | | | | from hydration by |
| | | | | | water is minimized) |

As shown in Table 1, Examples 1-2 had a good combination of tensile modulus, resistance to staining, and peg board wet and dry deflection. The difference between the peg board wet and dry deflection for both Examples 1 and 2 was significantly improved compared to the material in Comparative Example 1, which indicated that the TPU polymer had good moisture resistance.

Various embodiments of the invention have been described. These and other embodiments are within the scope of the following claims.

1. A method comprising reactively extruding a polymeric composition to form a film, the polymeric composition comprising a polyisocyanate and at least one dimer fatty diol.

2. The method of claim 1, wherein the polymeric composition is extruded at a temperature of less than about 200° C.

3. The method of claim 1, wherein the polyisocyanate comprises an isocyanate with a functionality of at least 2.

4. The method of claim 3, wherein the isocyanate is aromatic and is chosen from tolylene diisocyanate, m-phenylene diisocyanate, p-phenylene diisocyanate, xylylene diisocyanate, 4,4′-diphenylmethane diisocyanate (MDI), 2,4′-diphenylmethane diisocyanate, polymethylenepolyphenyl diisocyanate, 3,3′-dimethyl-4,4′-biphenylene diisocyanate, 3,3′-dimethyl-4,4′-diphenylmethane diisocyanate, 3,3-dichloro-4,4′-biphenylene diisocyanate, 1,5-naphthalene diisocyanate, hydrogenated MDI (4,4′-Methylenebis(cyclohexyl isocyanate)) and uretonimine-modified compounds thereof.

5. The method of claim 4, wherein the isocyanate is 4,4′-diphenylmethane diisocyanate (MDI).

6. The method of claim 1, wherein the dimer fatty diol is derived from a fatty acid with a C10 to C30 alkyl chain.

7. The method of claim 6, wherein the fatty acid is chosen from oleic acid, linoleic acid, linolenic acid, palmitoleic acid, elaidic acid, and mixtures and combinations thereof.

8. The method of claim 1, wherein the polymeric composition further comprises a hydroxyl functional chain extender chosen from aliphatic polyols, and wherein the polyol is an alkyl polyol.

9. The method of claim 1, wherein the polymeric composition comprises about 20 wt % to about 80 wt % of polyisocyanate and about 5 wt % to about 70 wt % of the dimer fatty diol.

10. The method of claim 9, wherein the polymeric composition comprises about 0 wt % to about 35 wt % of the chain extender.

11. The method of claim 1, further comprising crosslinking the film.

12. The method of claim 1, wherein the polymeric composition further comprises a crosslinker chosen from vinyl diols having the formula HX—R—XH; wherein X is O, S, NH or NR1, where R1 is an alkylene group comprising 1 to 4 carbon atoms; and R is an organic vinyl linking group that comprises 1 to 50 carbon atoms.

13. The method of claim 1, and further comprising thermoforming the film to create therein cavities configured to receive one or more teeth and form the dental appliance.

14. The method of claim 13, wherein the dental appliance has at least one of a tensile modulus of about 0.8 to about 2.0 GPa and a coffee stain index of less than about 3.

15. (canceled)

16. The polymeric film construction of claim 15, wherein the film construction is co-extruded.

17. A polymeric film construction comprising:
a first film layer;
a second film layer;
an intermediate film layer between the first film layer and the second film layer,
wherein either
each of the first and second film layers comprise a polyester, a polycarbonate, and mixtures and combinations thereof and the intermediate film layer is a thermoplastic polyurethane comprising a polyisocyanate and at least one dimer fatty diol, or
each of the first and second film layers comprise a thermoplastic polyurethane comprising a polyisocyanate and at least one dimer fatty diol and the intermediate film layer comprises a polyester, a polycarbonate, and mixtures and combinations thereof.

18. The polymeric film construction of claim 17, wherein the first film layer is different from the second film layer.

19. The polymeric film construction of claim 17, wherein the first film layer and the second film layer are independently chosen from polyethylene terephthalate (PET), polyethylene terephthalate glycol (PETG), polycyclohexylenedimethylene terephthalate (PCT), polycyclohexylenedimethylene terephthalate glycol (PCTG), Tritan, polycarbonate (PC), and mixtures and combinations thereof.

20. A method of making a dental appliance, comprising:
co-extruding:
a first polymeric film composition comprising a polyisocyanate and at least one dimer fatty diol; and
a second polymeric film composition comprising at least one polyester, to form a multi-layered film with at least one film layer of the first polymeric film composition and at least one film layer of the second polymeric film composition; and
thermoforming the multi-layered film to create therein a plurality of cavities for receiving one or more teeth and make the dental appliance.
